(19) United States
(12) Patent Application Publication
(10) Pub. No.: US 2022/0179583 A1
(43) Pub. Date: Jun. 9, 2022

(54) DATA BUFFER METHOD AND DEVICE

(71) Applicant: Realtek Singapore Private Limited, Singapore (SG)

(72) Inventor: Hongyi Qian, Singapore (SG)

(21) Appl. No.: 17/301,038

(22) Filed: Mar. 23, 2021

(30) Foreign Application Priority Data
Dec. 3, 2020 (TW) 109142693

(51) Int. Cl. G06F 3/06

(52) U.S. Cl. CPC G06F 3/0656; G06F 3/0673; G06F 3/0604

(57) ABSTRACT

A data buffer method and a device are provided. The device includes an upstream module, a downstream module and a buffer circuit which includes a plurality of storage units coupled between the upstream module and the downstream module. The data buffer method includes: performing a plurality of write/read rounds on the buffer circuit. Each of write/read rounds further includes: performing a write operation on the buffer circuit in a writing order by the upstream module and performing a read operation on the buffer circuit in a reading order by the downstream module. The writing order and the reading order in the same write/read round are different.

### CROSS-REFERENCE TO RELATED APPLICATION

This non-provisional application claims priority under 35 U.S.C. § 119(a) to Patent Application No. 109142693 in Taiwan, R.O.C. on Dec. 3, 2020, the entire contents of which are hereby incorporated by reference.

### BACKGROUND

### Technical Field

The present invention relates to a data transmission technology, and in particular to a data buffer method and a device.

### Related Art

In order to avoid power consumption caused by frequent storage and reading of the memory during data transfer between two electronic components, a buffer can be connected in series between the two electronic components for a data transmitting end to store data to be transferred, and for a data receiving end to read data stored in the buffer. However, the problem of data loss will inevitably occur when the two electronic components store and read the same buffer at the same time. For example, data is written into a certain area of the buffer and then new data is written into the area before the area is read. Especially when the two electronic components have different access orders for the buffer, this problem is particularly prone to occur.

In order to solve this problem, there is a method of using two buffers, in which the data transmitting end alternately writes data into the two buffers for the data reading end to read. In this way, although the problem of data loss can be solved, twice the buffer cost is required.

### SUMMARY

In view of the above problem, the present invention provides a data buffer method applied to a device. The device includes an upstream module, a downstream module and a buffer circuit which includes a plurality of storage units coupled between the upstream module and the downstream module. The pipelining data transmission method includes: performing a plurality of write/read rounds on the buffer circuit. Each of write/read rounds further comprises: performing a write operation on the buffer circuit in a writing order by the upstream module; and performing a read operation on the buffer circuit in a reading order by the downstream module; where the writing order and the reading order in the same write/read round are different.

An embodiment of the present invention further provides a data buffer method applied to a device. The device includes an upstream module, a downstream module and a buffer circuit which includes a plurality of storage units coupled between the upstream module and the downstream module. The pipelining data transmission method includes: performing a plurality of write/read rounds on the buffer circuit. Each of write/read rounds further comprises: performing a write operation on the buffer circuit in a writing order by the upstream module; and performing a read operation on the buffer circuit in a reading order by the downstream module; where in consecutive two of the write/read rounds, the writing order corresponding to the following write/read rounds is the same as the reading order corresponding to the previous write/read rounds.

An embodiment of the present invention further provides a device, including an upstream module, a downstream module and a buffer circuit. The buffer coupled between the upstream module and the downstream module, includes a plurality of storage units. The device performs a plurality of write/read rounds. In each of the write/read rounds, the upstream module performs a write operation on the buffer circuit in a writing order, and the downstream module performs a read operation on the buffer circuit in a reading order. The writing order and the reading order in the same write/read round are different.

According to the device and the data buffer method provided by the embodiments of the present invention, in the case of using a single buffer, the upstream module and the downstream module can use the respective writing order and reading order to access the buffer, and at the same time, the problem of data loss caused by overwriting of unread data can be avoided.

### BRIEF DESCRIPTION OF THE DRAWINGS

FIG. 1 is a schematic diagram of the architecture of a data pipeline device according to an embodiment of the present invention;

FIG. 2 is a flowchart of a data buffer method according to an embodiment of the present invention;

FIG. 3 is a schematic diagram of performing a write operation on a buffer according to an embodiment of the present invention;

FIG. 4 is a schematic diagram of performing a read operation on the buffer according to an embodiment of the present invention; and

FIG. 5 is a detailed flowchart of a data buffer method according to an embodiment of the present invention.

### DETAILED DESCRIPTION

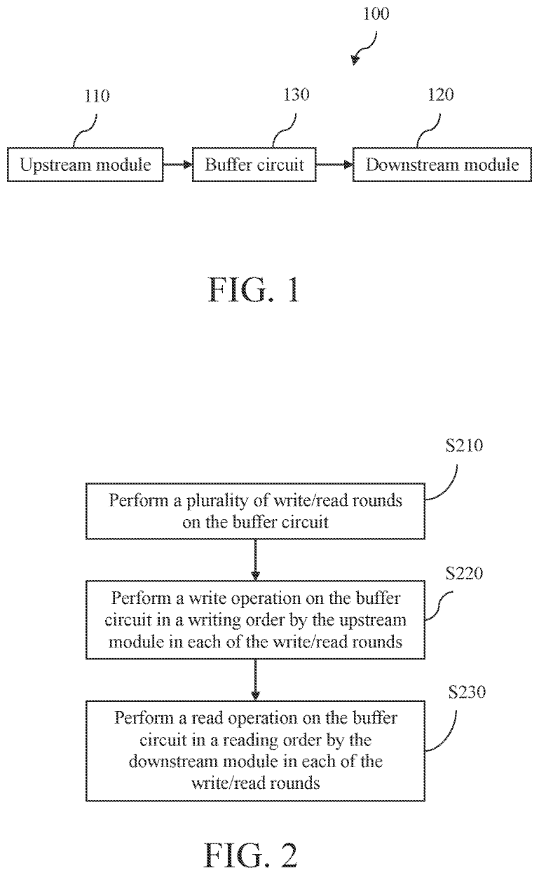

Referring to FIG. 1, FIG. 1 is a schematic diagram of the architecture of a data pipeline device according to an embodiment of the present invention. A data pipeline device 100 includes an upstream module 110, a downstream module 120 and a buffer circuit 130 coupling between the upstream module 110 and the downstream module 120. The upstream module 110 and the downstream module 120 are two independent electronic devices respectively. In some embodiments, the upstream module 110 is an image sensor, the downstream module 120 is an image encoder, and the transmitted data is image data. For the convenience of description, this application scenario will be described as an example below, but the present invention is not limited to this application scenario. In some embodiments, the downstream module 120 is an image encoder conforming to the architecture of high efficiency video coding (HEVC).

Referring FIG. 2, FIG. 2 is a flowchart of a data buffer method according to an embodiment of the present invention. The data buffer method is applied to the above-mentioned data pipeline device 100 so that the upstream module 110 can transmit data to the downstream module 120.

In step S210, a plurality of write/read rounds are performed. One write/read round means that the upstream module 110 completely writes a piece of data into the buffer circuit 130 and the downstream module 120 completely reads the piece of data from the buffer circuit 130. The piece of data, taking image data as an example, may be, for example, an image, a slice of an image, or the like. In some embodiments, in one write/read round, the read operation is started after the write operation is completed. In two consecutive write/read rounds, the write operation of the next round may be started before the read operation of the previous round is completed.

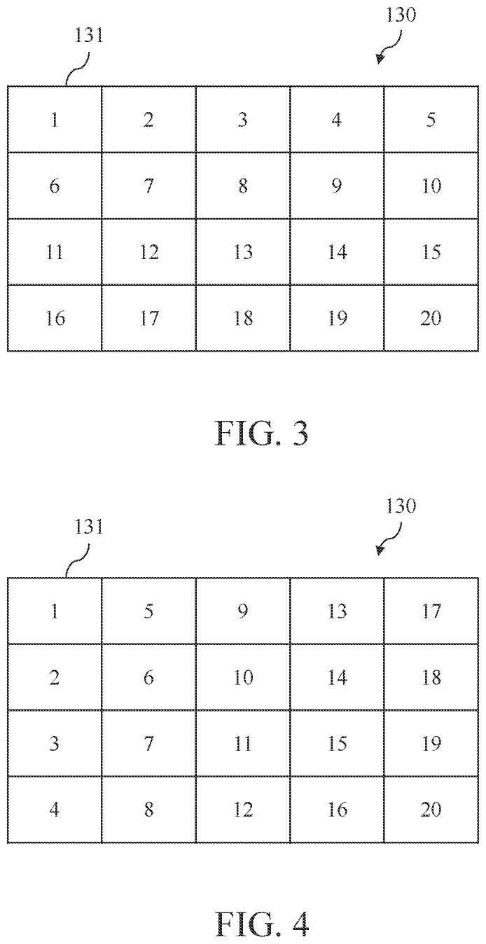

Referring to FIG. 3, FIG. 3 is a schematic diagram of performing a write operation on a buffer circuit 130 according to an embodiment of the present invention. The buffer circuit 130 includes a plurality of storage units 131. The storage unit 131 is the smallest unit for performing one write operation or read operation. The storage unit 131 includes one or more storage cells (not shown). The storage cell is the smallest memory unit in the buffer circuit 130. For example, the storage capacity of one storage cell is one byte, and the storage capacity of one storage unit 131 is four bytes (that is, one storage unit 131 has four storage cells). For the convenience of description, a buffer circuit 130 having 20 storage units 131 is taken as an example here, but the present invention is not limited to this number, and should include fewer or more storage units 131. Here, the storage unit 131 is in a two-dimensional arrangement manner of four rows and five columns. In some embodiments, the number of storage units 131 in one row (here, five) is positively correlated with a stride of the image data. Specifically, one row of the storage units 131 can store a plurality of rows of pixel data of the image. In some embodiments, the number of storage units 131 in one column (here, four) is positively correlated with the height of the image data, that is, one column of the storage units 131 can store a plurality of columns of pixel data of the image. In some embodiments, one storage unit 131 may store one coding tree unit (CTU).

In step S220, the upstream module 110 performs a write operation on each of the storage units 131 in a writing order in each of the write/read rounds. As shown in FIG. 3, the number marked in the storage unit 131 is the ordinal of the write operation performed on each of the storage units 131. The number “1” represents the first storage unit 131 to perform the write operation, the number “2” represents the second storage unit 131 to perform the write operation, and so on. In the example shown in FIG. 3, after the storage units 131 in the first row are written sequentially from left to right, the storage units 131 in the second row are written from left to right, then the storage units 131 in the third row are written from left to right, and finally the storage units 131 in the fourth row are written from left to right. This order can generally be called a raster order.

In step S230, the downstream module 120 performs a read operation on each of the storage units 131 in a reading order in each of the write/read rounds. Referring to FIG. 4, FIG. 4 is a schematic diagram of performing a read operation on a buffer circuit 130 according to an embodiment of the present invention. The number marked in the storage unit 131 is the ordinal of the read operation performed on each of the storage units 131. The number “1” represents the first storage unit 131 to perform the read operation, the number “2” represents the second storage unit 131 to perform the read operation, and so on. In the example shown in FIG. 4, after the storage units 131 in the first column from the left are read from top to bottom, the storage units 131 in the second column from the left are read from top to bottom, then the storage units 131 in the third column from the left are read from top to bottom, then the storage units 131 in the fourth column from the left are read from top to bottom, and finally the storage units 131 in the fifth column from the left are read from top to bottom. This order can generally be called a tile order.

For the convenience of description, the address of the storage unit 131 is defined as the ordinal as shown in FIG. 3 in the following embodiment. That is, the address of the storage unit 131 in the first column and the first row is “1”, the address of the storage unit 131 in the first row and the second column is “2”, and so on. The above-mentioned writing order refers to a sequence formed by arranging the address corresponding to each of the storage units 131 in an order of performing the write operations. The above-mentioned reading order refers to a sequence formed by arranging the address corresponding to each of the storage units 131 in an order of performing the read operations.

Referring to Table 1, Table 1 shows a writing order and a reading order of a plurality of write/read rounds according to an embodiment of the present invention. It can be seen that in consecutive two of the write/read rounds, the writing order corresponding to the following write/read rounds is the same as the reading order corresponding to the previous write/read rounds. For example, the writing order of the second write/read round is the same as the reading order of the first write/read round, and the writing order of the third write/read round is the same as the reading order of the second write/read round. Thus, in consecutive two of the write/read rounds, if the performing ordinal of the writing order corresponding to the following write/read rounds is smaller than the performing ordinal of the reading order corresponding to the previous write/read rounds, new data will not be written into the storage unit 131 that has not been read, causing data loss. For example, when the performing ordinal of the reading order is “5”, the performing ordinal of the writing order can be “1”, “2”, “3” or “4”, but cannot be “5” or its subsequent ordinal. The performing ordinal refers to the ordinal of the address of the storage unit 131 in the writing order that is currently to perform the write operation. For example, in the writing order in the second write/read round, if the write operation is to be performed on the storage unit 131 with the address “16” currently, then the performing ordinal is “4”.

TABLE 1

| | First | | Second | | Third | | Fourth | | Fifth | |
|---|---|---|---|---|---|---|---|---|---|---|
| | write/read | | write/read | | write/read | | write/read | | write/read | |
| | round | | round | | round | | round | | round | |
| | Writing | Reading | Writing | Reading | Writing | Reading | Writing | Reading | Writing | Reading |
| Ordinal | order | order | order | order | order | order | order | order | order | order |
| 1 | 1 | 1 | 1 | 1 | 1 | 1 | 1 | 1 | 1 | 1 |
| 2 | 2 | 6 | 6 | 7 | 7 | 12 | 12 | 18 | 18 | 10 |
| 3 | 3 | 11 | 11 | 13 | 13 | 4 | 4 | 16 | 16 | 19 |
| 4 | 4 | 16 | 16 | 19 | 19 | 15 | 15 | 14 | 14 | 9 |
| 5 | 5 | 2 | 2 | 6 | 6 | 7 | 7 | 12 | 12 | 18 |
| 6 | 6 | 7 | 7 | 12 | 12 | 18 | 18 | 10 | 10 | 8 |
| 7 | 7 | 12 | 12 | 18 | 18 | 10 | 10 | 8 | 8 | 17 |
| 8 | 8 | 17 | 17 | 5 | 5 | 2 | 2 | 6 | 6 | 7 |
| 9 | 9 | 3 | 3 | 11 | 11 | 13 | 13 | 4 | 4 | 16 |
| 10 | 10 | 8 | 8 | 17 | 17 | 5 | 5 | 2 | 2 | 6 |
| 11 | 11 | 13 | 13 | 4 | 4 | 16 | 16 | 19 | 19 | 15 |
| 12 | 12 | 18 | 18 | 10 | 10 | 8 | 8 | 17 | 17 | 5 |
| 13 | 13 | 4 | 4 | 16 | 16 | 19 | 19 | 15 | 15 | 14 |
| 14 | 14 | 9 | 9 | 3 | 3 | 11 | 11 | 13 | 13 | 4 |
| 15 | 15 | 14 | 14 | 9 | 9 | 3 | 3 | 11 | 11 | 13 |
| 16 | 16 | 19 | 19 | 15 | 15 | 14 | 14 | 9 | 9 | 3 |
| 17 | 17 | 5 | 5 | 2 | 2 | 6 | 6 | 7 | 7 | 12 |
| 18 | 18 | 10 | 10 | 8 | 8 | 17 | 17 | 5 | 5 | 2 |
| 19 | 19 | 15 | 15 | 14 | 14 | 9 | 9 | 3 | 3 | 11 |
| 20 | 20 | 20 | 20 | 20 | 20 | 20 | 20 | 20 | 20 | 20 |
| p | 1 | 5 | 5 | 6 | 6 | 11 | 11 | 17 | 17 | 9 |

| | Sixth | | Seventh | | Eighth | | Ninth | |
|---|---|---|---|---|---|---|---|---|
| | write/read | | write/read | | write/read | | write/read | |
| | round | | round | | round | | round | |
| | Writing | Reading | Writing | Reading | Writing | Reading | Writing | Reading |
| Ordinal | order | order | order | order | order | order | order | order |
| 1 | 1 | 1 | 1 | 1 | 1 | 1 | 1 | 1 |
| 2 | 10 | 8 | 8 | 17 | 17 | 5 | 5 | 2 |
| 3 | 19 | 15 | 15 | 14 | 14 | 9 | 9 | 3 |
| 4 | 9 | 3 | 3 | 11 | 11 | 13 | 13 | 4 |
| 5 | 18 | 10 | 10 | 8 | 8 | 17 | 17 | 5 |
| 6 | 8 | 17 | 17 | 5 | 5 | 2 | 2 | 6 |
| 7 | 17 | 5 | 5 | 2 | 2 | 6 | 6 | 7 |
| 8 | 7 | 12 | 12 | 18 | 18 | 10 | 10 | 8 |
| 9 | 16 | 19 | 19 | 15 | 15 | 14 | 14 | 9 |
| 10 | 6 | 7 | 7 | 12 | 12 | 18 | 18 | 10 |
| 11 | 15 | 14 | 14 | 9 | 9 | 3 | 3 | 11 |
| 12 | 5 | 2 | 2 | 6 | 6 | 7 | 7 | 12 |
| 13 | 14 | 9 | 9 | 3 | 3 | 11 | 11 | 13 |
| 14 | 4 | 16 | 16 | 19 | 19 | 15 | 15 | 14 |
| 15 | 13 | 4 | 4 | 16 | 16 | 19 | 19 | 15 |
| 16 | 3 | 11 | 11 | 13 | 13 | 4 | 4 | 16 |
| 17 | 12 | 18 | 18 | 10 | 10 | 8 | 8 | 17 |
| 18 | 2 | 6 | 6 | 7 | 7 | 12 | 12 | 18 |
| 19 | 11 | 13 | 13 | 4 | 4 | 16 | 16 | 19 |
| 20 | 20 | 20 | 20 | 20 | 20 | 20 | 20 | 20 |
| p | 9 | 7 | 7 | 16 | 16 | 4 | 4 | 1 |

Referring to Table 1, the writing order and the reading order in the same write/read round are different. Thereby, the upstream module 110 and the downstream module 120 can write and read respectively according to their needs. For example, the upstream module 110 as an image sensor writes the image data into the buffer circuit 130 row by row, and the downstream module 120 as an image encoder needs to read the image data from the buffer circuit 130 tile by tile to perform encoding.

Referring to Table 1, there is a mapping relationship between the writing order and the reading order in the same write/read round, and the mapping relationship in each of the write/read rounds is the same. That is, in the same write/read round, there is a mapping relationship between the two addresses of the same ordinal in the writing order and the reading order. In each of the write/read rounds, the address in the writing order is mapped into the same address in the reading order. For example, in the first write/read round, the address with the ordinal “2” is “2” in the writing order, and the address also with the ordinal “2” is “6” in the reading order, while in other write/read rounds, the address “2” in the writing order is all mapped to the address “6” in the reading order (for example, the ordinal “5” in the second write/read round). Table 2 shows the mapping relationship between the addresses in the writing order and the addresses in the reading order according to an embodiment of the present invention.

TABLE 2

| | Address | | | | | | | | | | | | | | | | | | | |
|---|---|---|---|---|---|---|---|---|---|---|---|---|---|---|---|---|---|---|---|---|
| | Writing order | | | | | | | | | | | | | | | | | | | |
| | 1 | 2 | 3 | 4 | 5 | 6 | 7 | 8 | 9 | 10 | 11 | 12 | 13 | 14 | 15 | 16 | 17 | 18 | 19 | 20 |
| Reading order | 1 | 6 | 11 | 16 | 2 | 7 | 12 | 17 | 3 | 8 | 13 | 18 | 4 | 9 | 14 | 19 | 5 | 10 | 15 | 20 |

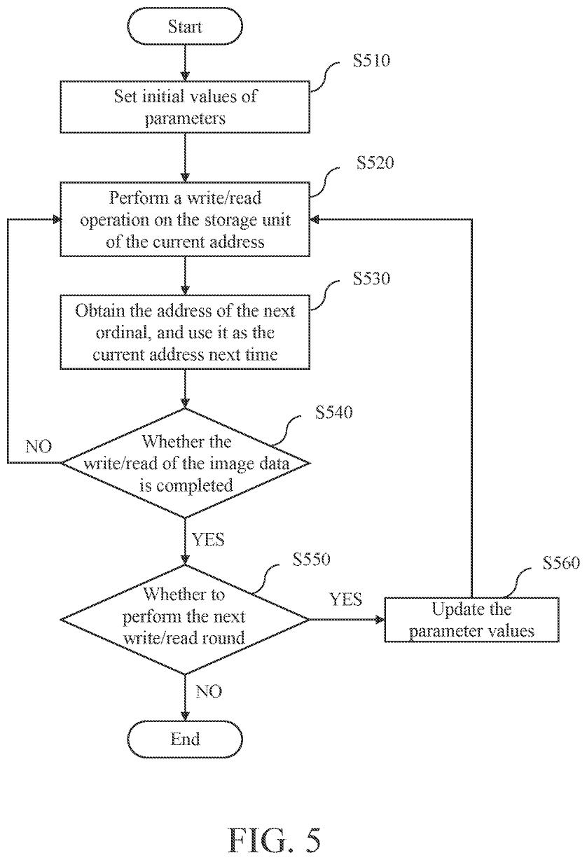

Referring FIG. 5, FIG. 5 is a detailed flowchart of a data buffer method according to an embodiment of the present invention. First, in step S510, initial values of parameters are set. The parameters are those used in the calculation formulae described later, and will be described later.

In step S520, the upstream module 110 performs a write operation on the storage unit 131 of the current address; and the downstream module 120 performs a read operation on the storage unit 131 of the current address. For the upstream module 110, the current address is the address corresponding to the current performing ordinal in the writing order. For the downstream module 120, the current address is the address corresponding to the current performing ordinal in the reading order. The current performing ordinal of the upstream module 110 and the current performing ordinal of the downstream module 120 may be different.

After step S520 is completed, the process proceeds to step S530. The address of the next performing ordinal is obtained, and used as the current address of the write or read operation performed next time. The calculation formula is shown as formula (1). Add(n) is the write address or read address of the current ordinal, and Add(n+1) is the write address or read address of the next ordinal. n is the current ordinal. p is the displacement between the current address and the next address. If Add(n+1) obtained by formula (1) is greater than z, then Add(n+1) is updated according to formula (2). z is the number of storage units 131. In this example, z is 20. n, p and z are positive integers. In addition, the initial values of the parameters set in step S510 are as follows: n is 1, Add(1) is 1, the initial value of p of the upstream module 110 is 1, and the initial value of p of the downstream module 120 is 5.

Add(n+1)=Add(n)+p formula (1)

Add(n+1)=Add(n+1)−z+1 formula (2)

In step S540, it is determined that whether the write or read of the image data is completed. If so, the process proceeds to step S550; and if not, the process returns to step S520 to continue performing the next write or read operation.

In step S550, it is determined whether to perform the next write/read round (that is, it is determined whether the writing order or reading order of the current write/read round is completed). If so, the process proceeds to step S560 to update the parameter values, the calculation formula is shown as formula (3); and if not, the process is ended. Formula (3) is the largest integer less than or equal to the product of p and s divided by z (or referred to as “floor”), plus the remainder of the product of p and s divided by z, which is used as the value of p of the next write/read round. s is a positive integer. In this example, s is positively correlated with a stride of the image data. Specifically, s is the number of storage units 131 in one row (here, 5), but the embodiments of the present invention are not limited to this, and s may also be set to other values. The value of p corresponding to the writing order and the reading order in each of the write/read rounds is shown in Table 1.

p=└p*s/z┘+(p*s)mod z formula (3)

In another embodiment, the parameter values are updated through formula (3-1) to formula (3-3) instead of formula (3), which can avoid multiplication and division calculations and can enhance calculation efficacy or reduce hardware cost. Before formula (3-1) is performed, formula (3-2) is performed p times to obtain the value of q. In the process of performing formula (3-2) p times, the result of performing formula (3-2) each time is checked. If the calculated value of q is greater than z, then the value of q is updated according to formula (3-3), and then the next calculation of formula (3-2) is performed. Finally, the calculated final value of q is used as the new value of p (that is, formula (3-1)), and the value of q is reset to 0. In addition, the initial values of the parameters set in step S510 mentioned above further include: the initial value of q is 0.

p=q formula (3-1)

q=q+ formula (3-2)

q=z+1 formula (3-3)

Based on the above, according to the device 100 and the data buffer method provided by the embodiments of the present invention, in the case of using a single buffer circuit 130, the upstream module 110 and the downstream module 120 can use the respective writing order and reading order to access the buffer circuit 130, and at the same time, the problem of data loss caused by overwriting of unread data can be avoided.

What is claimed is:

1. A data buffer method applied to a device, wherein the device comprises an upstream module, a downstream module and a buffer circuit comprising a plurality of storage units coupled between the upstream module and the downstream module, the method comprising:
performing a plurality of write/read rounds on the buffer circuit;
wherein each of write/read rounds further comprises:
performing a write operation on the buffer circuit in a writing order by the upstream module; and
performing a read operation on the buffer circuit in a reading order by the downstream module;
wherein the writing order and the reading order in the same write/read round are different.

2. The method according to claim 1, wherein in consecutive two of the write/read rounds, the writing order corresponding to the following write/read rounds is the same as the reading order corresponding to the previous write/read rounds.

3. The method according to claim 2, wherein there is a mapping relationship between the writing order and the reading order in the same write/read round, and the mapping relationship in each of the write/read rounds is the same.

4. The method according to claim 1, wherein in consecutive two of the write/read rounds, a performing ordinal of the writing order corresponding to the following write/read rounds is smaller than a performing ordinal of the reading order corresponding to the previous write/read rounds.

5. The method according to claim 1, wherein at least one of the writing order and the reading order is a sequence formed by arranging an address corresponding to each of the storage units in an order of performing related operations, which is expressed as formula (1), and if Add (n+1) obtained by formula (1) is greater than z, then Add (n+1) is updated according to formula (2), wherein Add(n+1) is a write address of a current ordinal, Add(n+1) is a write address of a next ordinal, z is the number of the storage units, n is the current ordinal, and n, p, s, and z are positive integers.
Add(n+1)=Add(n)+p formula (1)
Add(n+1)=Add(n+1)−z+1 formula (2)

6. The method according to claim 1, wherein after the write/read round is completed, the value of p is updated according to formula (3).
p=└p*s/z┘+(p*s)mod z formula (3)

7. The method according to claim 5, wherein after the write/read round is completed, the value of p is updated according to formula (3-1);
p= formula (3-1)
q=q+s formula (3-2)
q=q−z+1 formula (3-3)
wherein before performing formula (3-1), formula (3-2) is performed p times to obtain the value of q, wherein if the value of q after performing formula (3-2) each time is greater than z, then the value of q is updated according to formula (3-3), wherein q is a positive integer.

8. The method according to claim 5, wherein each of the write/read rounds is to write an image data to the buffer and read the image data from the buffer, wherein s is positively correlated with a stride of the image data.

9. A data buffer method applied to a device, wherein the device comprises an upstream module, a downstream module and a buffer circuit comprising a plurality of storage units coupled between the upstream module and the downstream module, the method comprising:
performing a plurality of write/read rounds on the buffer circuit;
wherein each of write/read rounds further comprises:
performing a write operation on the buffer circuit in a writing order by the upstream module; and
performing a read operation on the buffer circuit in a reading order by the downstream module;
wherein in consecutive two of the write/read rounds, the writing order corresponding to the following write/read rounds is the same as the reading order corresponding to the previous write/read rounds.

10. A device, comprising:
an upstream module;
a downstream module; and
a buffer circuit, coupled between the upstream module and the downstream module, comprising a plurality of storage units;
wherein the device performs a plurality of write/read rounds,
wherein in each of the write/read rounds, the upstream module performs a write operation on the buffer circuit in a writing order, and the downstream module performs a read operation on the buffer circuit in a reading order;
wherein the writing order and the reading order in the same write/read round are different.

11. The device according to claim 10, wherein in consecutive two of the write/read rounds, the writing order corresponding to the following write/read rounds is the same as the reading order corresponding to the previous write/read rounds.

12. The device according to claim 11, wherein there is a mapping relationship between the writing order and the reading order in the same write/read round, and the mapping relationship in each of the write/read rounds is the same.

13. The device according to claim 10, wherein in consecutive two of the write/read rounds, a performing ordinal of the writing order corresponding to the following write/read rounds is smaller than a performing ordinal of the reading order corresponding to the previous write/read rounds.

14. The device according to claim 10, wherein at least one of the writing order and the reading order is a sequence formed by arranging an address corresponding to each of the storage units in an order of performing related operations, which is expressed as formula (1), and if Add (n+1) obtained by formula (1) is greater than z, then Add (n+1) is updated according to formula (2), wherein Add (n) is a write address of a current ordinal, Add (n+1) is a write address of a next ordinal, z is the number of the storage units, n is the current ordinal, and n, p, s, and z are positive integers.
Add(n+1)=Add(n)+p formula (1)
Add(n+1)=Add(n+1)−z+1 formula (2)

15. The device according to claim 14, wherein after the write/read round is completed, the value of p is updated according to formula (3).
p=└p*s/z┘+(p*s)mod z formula (3)

16. The device according to claim 14, wherein after the write/read round is completed, the value of p is updated according to formula (3-1);
p=q formula (3-1)
q=q+s formula (3-2)
q=q−z+1 formula (3-3)
wherein before performing formula (3-1), formula (3-2) is performed p times to obtain the value of q, wherein if the value of q after performing formula (3-2) each time is greater than z, then the value of q is updated according to formula (3-3), wherein q is a positive integer.

17. The device according to claim 14, wherein s is positively correlated with a stride of data.
